(19) United States
(12) Patent Application Publication
(10) Pub. No.: US 2024/0221986 A1
(43) Pub. Date: Jul. 4, 2024

(54) SOLENOID, SOLENOID VALVE, SUSPENSION DEVICE, AND METHOD OF ASSEMBLING SOLENOID

(71) Applicant: Hitachi Astemo, Ltd., Hitachinaka-shi (JP)

(72) Inventors: Gota NAKANO, Hitachinaka-shi (JP); Seiryo KONAKAI, Hitachinaka-shi (JP)

(73) Assignee: Hitachi Astemo, Ltd., Hitachinaka-shi (JP)

(21) Appl. No.: 18/606,801

(22) Filed: Mar. 15, 2024

Related U.S. Application Data
(63) Continuation of application No. PCT/JP2023/017029, filed on May 1, 2023.

(30) Foreign Application Priority Data
May 10, 2022 (JP) 2022-077806

(51) Int. Cl. H01F 7/128; B60G 17/056; F16K 31/06

(52) U.S. Cl. CPC H01F 7/128; B60G 17/056; B60G 2600/26; F16K 31/0641

(57) ABSTRACT

A solenoid includes: a covering portion including a peripheral portion to cover a periphery of a coil contained in a cylindrical housing, the covering portion covering an opening 61 of the housing; a sleeve provided around an outer periphery of the covering portion, the sleeve being configured to be disassemblable; and a sealing element disposed inside the sleeve, the sealing element being configured to prevent foreign matters from entering the housing.

### CROSS REFERENCE TO RELATED APPLICATIONS

This application is a Continuation of International Patent Application No. PCT/JP2023/017029 filed on May 1, 2023, which claims the benefit of priority to Japanese Patent Application No. 2022-077806 filed on May 10, 2022, the contents of all of which are incorporated herein by reference in their entireties.

### FIELD OF THE INVENTION

The present invention relates to a solenoid, a solenoid valve, a suspension device, and a method of assembling a solenoid.

### BACKGROUND OF THE INVENTION

Some techniques have been proposed to prevent solenoid malfunctions caused by foreign matters entering a housing.

For example, a solenoid disclosed in Japanese Patent No. 6852051 includes: a housing including a top opening and configured to receive, through the top opening, a solenoid body with a coil wound around a bobbin; a primary package made of mold resin that covers the solenoid body, the primary package being configured to be mounted on the top opening of the housing to form a gap between the primary package and the top opening; and a secondary package made of mold resin that covers the primary package to close the gap.

For example, Japanese Patent Application Laid-Open Publication No. 2014-199076 discloses the use of a solenoid as a component for generating a damping force for shock absorbers installed in vehicles.

### CITATION LIST

### Patent Literature

Patent Literature 1: Japanese Patent No. 6852051

Patent Literature 2: Japanese Patent Application Laid-Open Publication No. 2014-199076

### Technical Problem

The solenoid disclosed in Japanese Patent No. 6852051 is assembled by joining the primary package and the secondary package, leaving room for improvements in terms of productivity.

It is an object of the present invention to provide a solenoid etc. that allow for improved productivity.

### SUMMARY OF THE INVENTION

### Solution to Problem

With the above object in view, an aspect of the present invention relates to a solenoid.

The solenoid includes: a first member including a peripheral portion to cover a periphery of a coil contained in a cylindrical housing, the first member covering an opening of the housing; a second member provided around an outer periphery of the first member, the second member being configured to be disassemblable; and a sealing element disposed inside the second member, the sealing element being configured to prevent foreign matters from entering the housing.

Another aspect of the present invention relates to a solenoid. The solenoid includes: a first member including a peripheral portion to cover a periphery of a coil contained in a cylindrical housing, the first member covering an opening of the housing; and a second member provided around an outer periphery of the first member in a disassemblable manner, the second member being elastic and cylindrically shaped, the second member being configured to prevent foreign matters from entering the housing.

Still another aspect of the present invention relates to a method of assembling a solenoid. The solenoid includes: a first member including a peripheral portion to cover a periphery of a coil contained in a cylindrical housing, the first member covering an opening of the housing; a second member provided around an outer periphery of the first member, the second member being configured to be disassemblable; and a sealing element disposed inside the second member, the sealing element being configured to prevent foreign matters from entering the housing. The method includes: inserting the peripheral portion into the housing in a state where the second member is coupled to an outer periphery of the first member with the sealing element disposed inside the second member.

### Advantageous Effects of Invention

The present invention can improve productivity.

### BRIEF DESCRIPTION OF THE DRAWINGS

FIG. 1 illustrates an example schematic configuration of a suspension device according to a first embodiment.

FIG. 2 illustrates an example cross-section of a solenoid according to the first embodiment.

FIG. 3 is an enlarged view of part III-III in FIG. 2.

FIG. 4 is a perspective view of components of the solenoid according to the first embodiment, as viewed obliquely from the second side.

FIG. 5 is a perspective view of the components of the solenoid according to the first embodiment, as viewed obliquely from the first side.

FIG. 6 illustrates an example schematic configuration of a solenoid according to a second embodiment.

FIG. 7 is a perspective view of components of the solenoid according to the second embodiment, as viewed obliquely from the second side.

FIG. 8 is a perspective view of the components of the solenoid according to the second embodiment, as viewed obliquely from the first side.

FIG. 9 illustrates an example schematic configuration of a solenoid according to a third embodiment.

FIG. 10 is a perspective view of components of the solenoid according to the third embodiment, as viewed obliquely from the second side.

FIG. 11 is a perspective view of the components of the solenoid according to the third embodiment, as viewed obliquely from the first side.

FIG. 12 illustrates an example schematic configuration of a solenoid according to a fourth embodiment.

FIG. 13 illustrates example variations of a cover unit and a sleeve.

FIG. 14 illustrates an example schematic configuration of a solenoid according to a fifth embodiment.

FIG. 15 illustrates a schematic configuration of a sleeve according to a first variation.

FIG. 16 illustrates a schematic configuration of a sleeve according to a second variation.

FIG. 17 illustrates an example schematic configuration of a solenoid according to a sixth embodiment.

FIG. 18 illustrates an example schematic configuration of a solenoid according to a seventh embodiment.

FIG. 19 illustrates a schematic configuration of a sleeve according to a first variation.

FIG. 20 illustrates an example schematic configuration of a solenoid according to an eighth embodiment.

FIG. 21 illustrates an example schematic configuration of a solenoid according to a ninth embodiment.

FIG. 22 illustrates an example sleeve according to a variation.

FIG. 23 illustrates an example schematic configuration of a solenoid according to a tenth embodiment.

FIG. 24 illustrates an example sleeve according to a first variation.

FIG. 25 illustrates an example sleeve according to a second variation.

### DETAILED DESCRIPTION OF THE INVENTION

Exemplary embodiments of the present invention will be detailed below with reference to the appended drawings.

### <First Embodiment>

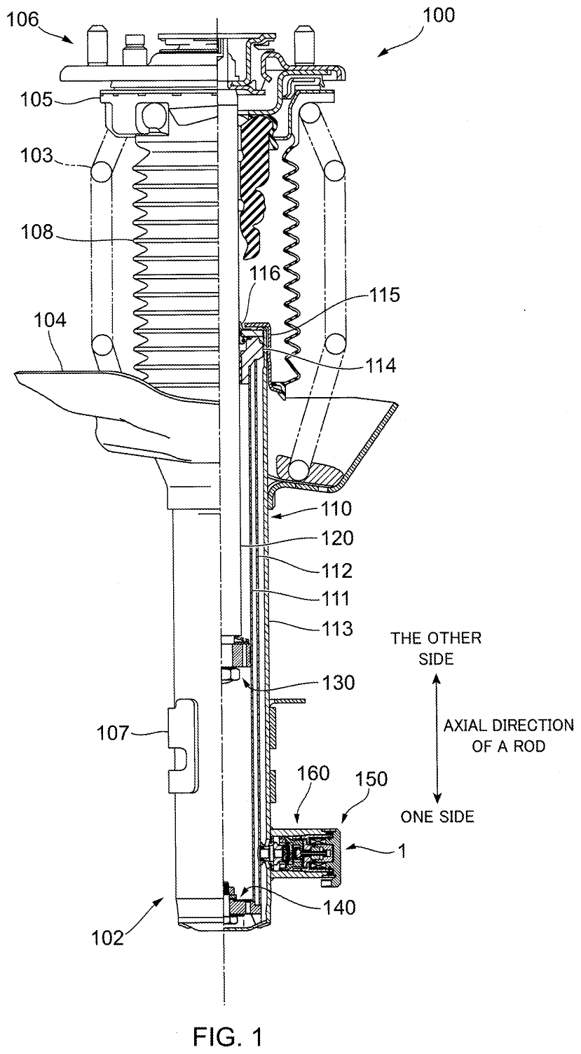

FIG. 1 illustrates an example schematic configuration of a suspension device 100 according to a first embodiment.

The suspension device 100 is a suspension strut and, as shown in FIG. 1, includes a hydraulic shock absorber 102 and a coil spring 103 disposed outside the hydraulic shock absorber 102. The suspension device 100 further includes a lower spring seat 104 and an upper spring seat 105, where the lower spring seat 104 supports one end (lower end in FIG. 1) of the coil spring 103 in the axial direction of a rod 120 (described below), and the upper spring seat 105 supports the other end (upper end in FIG. 1) of the coil spring 103 in the axial direction of the rod 120.

The suspension device 100 further includes a vehicle body-side bracket 106 and a wheel-side bracket 107, where the vehicle body-side bracket 106 is attached to the other axial end of the rod 120 for attaching the suspension device 100 to the vehicle, and the wheel-side bracket 107 is secured to one end of a cylinder unit 110 (described below) in the axial direction of the rod 120 for attaching the suspension device 100 to a wheel. The suspension device 100 further includes a dust cover 108 to cover at least portions of the cylinder unit 110 and the rod 120. The vehicle body-side bracket 106 is attached to the other axial end of the rod 120.

The hydraulic shock absorber 102 includes the cylinder unit 110 to contain oil as an example of a working fluid, and the rod 120 having one end protruding from the cylinder unit 110 and the other end slidably inserted into the cylinder unit 110. The hydraulic shock absorber 102 further includes a piston unit 130 provided at one end of the rod 120, and a bottom unit 140 provided at one end of the cylinder unit 110. The hydraulic shock absorber 102 further includes an outer damping unit 150 provided outside of the cylinder unit 110 to generate damping force.

The cylinder unit 110 includes a cylinder 111 to contain oil, an outer cylindrical body 112 provided outside of the cylinder 111, and a damper case 113 provided outside of the outer cylindrical body 112. The cylinder unit 110 further includes a rod guide unit 114 to support the rod 120 such that the rod 120 is movable, a bump stopper cap 115 attached to one end of the damper case 113, and an oil seal 116 to prevent oil from leaking from the damper case 113 and foreign matters from entering the damper case 113.

### [Outer Damping Unit 150]

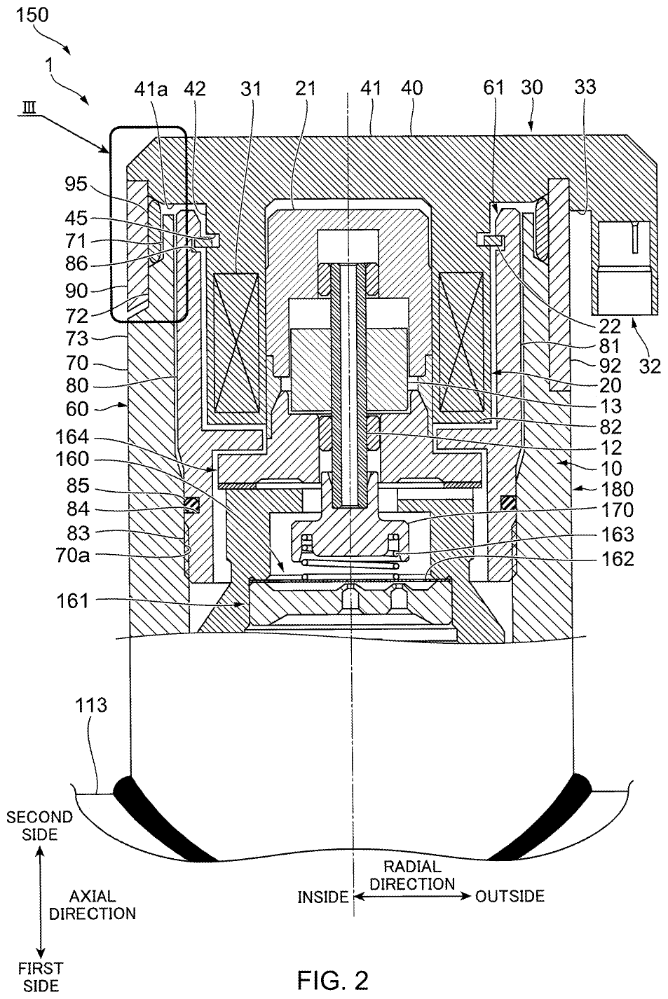

FIG. 2 illustrates an example cross-section of a solenoid 1 according to the first embodiment.

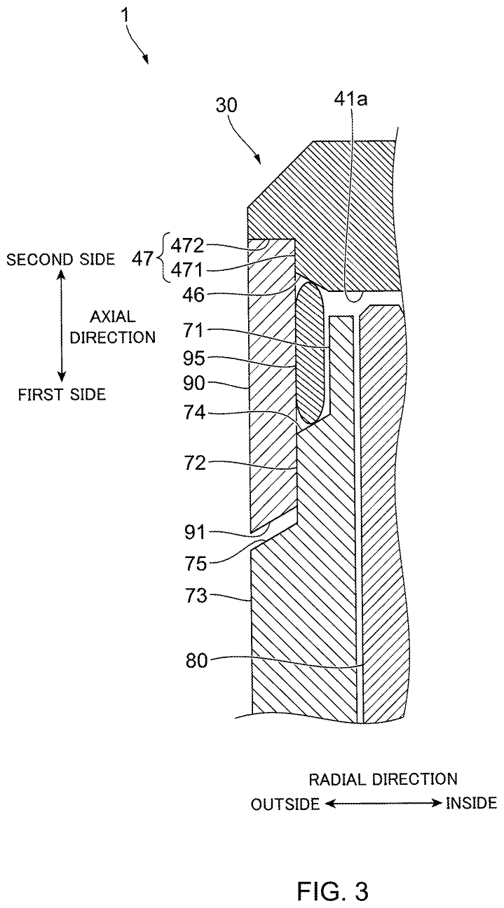

FIG. 3 is an enlarged view of part III-III in FIG. 2.

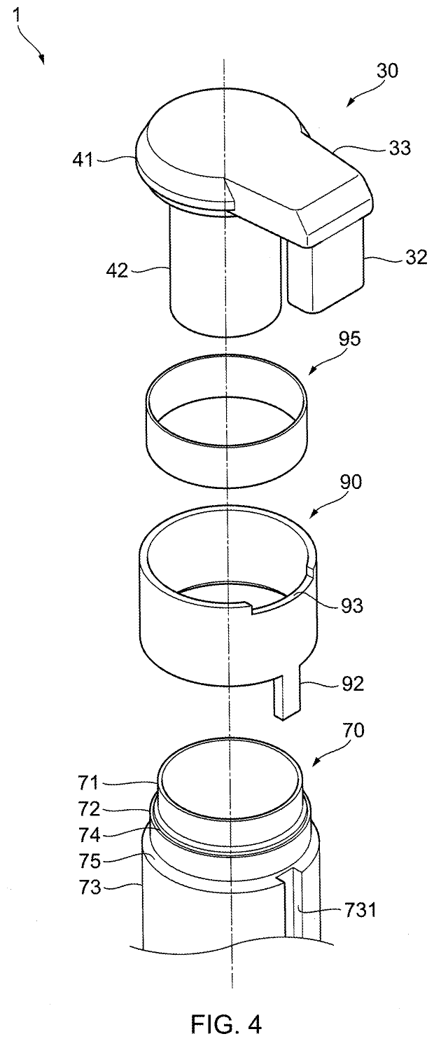

FIG. 4 is a perspective view of components of the solenoid 1 according to the first embodiment, as viewed obliquely from the second side.

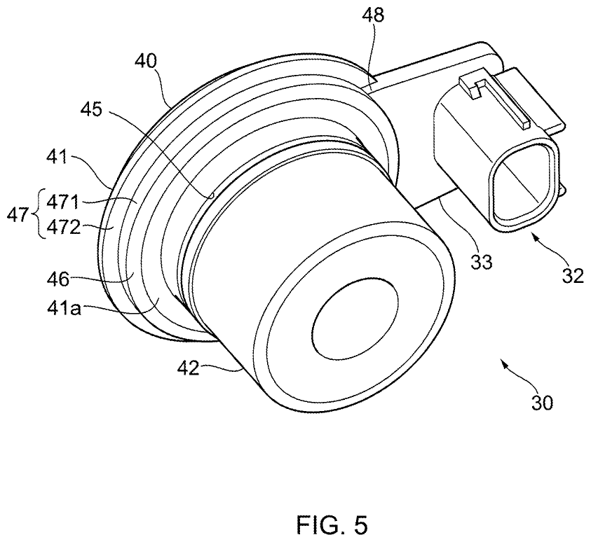

FIG. 5 is a perspective view of the components of the solenoid 1 according to the first embodiment, as viewed obliquely from the first side.

The outer damping unit 150 includes a damping force mechanism unit 160 to generate damping force and a solenoid 1 to adjust the damping force of the damping force mechanism unit 160.

The damping force mechanism unit 160 includes an orifice plate 161 formed with channels and a pilot valve 162 to open and close the channels of the orifice plate 161. The damping force mechanism unit 160 further includes a compression coil spring 163 to apply a force to the pilot valve 162 in the direction that causes the pilot valve 162 to close the channels of the orifice plate 161, and a support member 164 to slidably support a plunger 12 (described below). The damping force mechanism unit 160 is not limited to a particular configuration and may be of any configuration. Hence, FIG. 2 and the subsequent figures omit illustration of other components of the damping force mechanism unit 160.

The solenoid 1 is now detailed below.

The solenoid 1 includes a valve unit 10 to open and close the channels, a solenoid unit 20 to drive the plunger 12 (described below) of the valve unit 10, and a housing 60 to contain the valve unit 10 as well as a coil 31 (described below) and other components of the solenoid unit 20. The solenoid 1 further includes an elastic sealing element 95 to seal a gap between the solenoid unit 20 and the housing 60, and a cylindrical sleeve 90 to cover the sealing element 95 on the outside of the sealing element 95.

The axial direction of the plunger 12 may be referred to hereinafter as the “axial direction.” The axial direction also corresponds to the centerline of the cylindrical housing 60. In the axial direction, the lower and upper sides in FIG. 2 may be referred to as the “first side” and “second side,” respectively. The direction intersecting the axial direction (e.g., perpendicular direction) is referred to as the “radial direction.” In the radial direction, the side closer to the centerline of the housing 60 may be referred to as the “inside,” and the side away from the centerline may be referred to as the “outside.”

### (Valve Unit 10)

The valve unit 10 includes the plunger 12 that holds an adjustment valve 170 to control the flow of oil in the orifice plate 161 formed with the channels, and a magnetic element 13, such as a magnet, secured to the plunger 12.

The adjustment valve 170 is disposed at a position opposite the pilot valve 162 in the axial direction. The adjustment valve 170 is movable in the axial direction and is capable of contacting the pilot valve 162 by moving toward the first side. As such, the adjustment valve 170 can be in any state between being in contact with the pilot valve 162 and being farthest away from the pilot valve 162. This allows the adjustment valve 170 to adjust the flow rate of oil flowing through the channels in the orifice plate 161. Hence, the adjustment valve 170 functions as an example of the valve configured to have its position adjusted by the solenoid 1 to adjust the force with which the oil opens and closes the channels. The adjustment valve 170 and the solenoid 1 constitute a solenoid valve 180.

The plunger 12 is a rod-like member formed along the axial direction. The plunger 12 holds the adjustment valve 170 at the first side and holds the magnetic element 13 at the center in the axial direction. The plunger 12 is supported by a fixed core 21 and the support member 164 (described below) such that the plunger 12 is movable in the axial direction via bearings. When the solenoid unit 20 is energized, the plunger 12 is pushed by the solenoid unit 20 toward the first side together with the adjustment valve 170. On the other hand, when the solenoid unit 20 is de-energized, the plunger 12 is pushed by the compression coil spring 163 back toward the second side together with the adjustment valve 170.

### (Housing 60)

The housing 60 includes a generally cylindrical outer housing 70 located on the outside and an inner housing 80 located on the inside relative to the outer housing 70. By way of example, the outer housing 70 and the inner housing 80 may be molded from metal. By way of alternative example, the outer housing 70 may be molded from metal and the inner housing 80 may be molded from resin.

The outer housing 70 is secured at its portion on the first side to the outer circumference surface of the damper case 113 of the cylinder unit 110 by e.g., welding or the like. The outer housing 70 is formed with a female thread 70a on its inner circumferential surface.

As shown in FIG. 2, the outer housing 70 includes a first cylindrical portion 71 at the second side end, a second cylindrical portion 72 on the first side relative to the first cylindrical portion 71, and a third cylindrical portion 73 on the first side relative to the second cylindrical portion 72. The first cylindrical portion 71, the second cylindrical portion 72, and the third cylindrical portion 73 have the same inner diameter. On the other hand, the outer diameter of the first cylindrical portion 71 is smaller than the outer diameter of the second cylindrical portion 72, and the outer diameter of the second cylindrical portion 72 is smaller than the outer diameter of the third cylindrical portion 73. The second side end of the second cylindrical portion 72 includes an inclined surface 74 that is inclined relative to the axial direction such that the diameter gradually increases from the second side toward the first side. The second side end of the third cylindrical portion 73 includes an inclined surface 75 that is inclined relative to the axial direction such that the diameter gradually increases from the second side toward the first side. The third cylindrical portion 73 includes a cutaway portion 731 formed in a portion of the circumference and depressed from the outer circumferential surface.

Coating is applied to an outer surface of the outer housing 70, including an outer circumference surface of the second cylindrical portion 72 and the inclined surface 75 and outer circumferential surface of the third cylindrical portion 73. By way of example, the coating may be a cationic electrodeposition coating with high corrosion resistance.

The inner housing 80 includes a cylindrical portion 81 of a generally cylindrical shape and an annular portion 82 of an annular shape protruding inward from the inner circumferential surface of the cylindrical portion 81.

The cylindrical portion 81 includes a male thread 83 formed on its first side end, which is tightened to the female thread 70a formed on the inner circumference surface of the outer housing 70. In addition, the cylindrical portion 81 includes a recess 84 formed in its portion on the second side relative to the male thread 83 and depressed from the outer circumferential surface. An O-ring 85 to seal a space between the outer circumferential surface of the inner housing 80 and the inner circumferential surface of the outer housing 70 is held in the recess 84.

The cylindrical portion 81 further includes a first engaging portion 86 formed on its second side end over the entire circumference and depressed from the inner circumferential surface.

### (Solenoid Unit 20)

The solenoid unit 20 includes a cover unit 30 to cover an opening of the housing 60, the fixed core 21, and a clip 22 to position the cover unit 30 relative to the housing 60 in the axial direction. When energized, the solenoid unit 20 pushes the plunger 12 toward the first side.

The clip 22 is a metal member having a rectangular cross-section when taken in a plane parallel to the axial direction, with the axial direction corresponding to the transverse direction and the radial direction corresponding to the longitudinal direction, and having a C-shaped cross-section when taken in a plane perpendicular to the axial direction.

The cover unit 30 includes the coil 31, a covering portion 40 to hold the coil 31 and cover the opening of the housing 60, a connector portion 32 for energizing the coil 31, and a junction 33 to connect the covering portion 40 and the connector portion 32. The cover unit 30 is molded by insert molding, in which the metal coil 31 and other parts are held in a mold, followed by filling resin heated to a softening temperature of the resin into the mold over the portions corresponding to the covering portion 40, the connector portion 32, and the junction 33. Thus, the covering portion 40, the connector portion 32, and the junction 33 are molded from mold resin.

The junction 33 protrudes in a rectangular shape outwardly from the outer periphery of the covering portion 40. The connector portion 32 protrudes toward the first side from the outside end of the junction 33.

The covering portion 40 includes a disk-shaped portion 41 of a disk shape to cover the opening of the housing 60, and a peripheral portion 42 protruding toward the first side from a first side end face 41a of the disk-shaped portion 41 to cover the periphery of the coil 31.

The disk-shaped portion 41 includes an inclined surface 46 that is inclined from the end face 41a relative to the axial direction such that the diameter gradually increases from the first side toward the second side. The disk-shaped portion 41 further includes a recess 47 formed outside of the inclined surface 46 and depressed from the end face 41a. The recess 47 is defined by a parallel surface 471 parallel to the axial direction and formed outside of the inclined surface 46 and a perpendicular surface 472 perpendicular to the axial direction and formed at the second side end. The disk-shaped portion 41 includes, in a portion of the circumference of the recess 47 at the position corresponding to the junction 33, a protrusion 48 protruding from the perpendicular surface 472 toward the first side. The protrusion 48 is formed to have the first side surface that lies flush with the first side surface of the junction 33.

The peripheral portion 42 is cylindrical and is located outside of the fixed core 21 and inside of the housing 60. The peripheral portion 42 includes the coil 31 at a position that overlaps, in the axial direction, the moving range of the magnetic element 13 secured to the plunger 12.

In addition, the peripheral portion 42 includes a second engaging portion 45 depressed from the outer circumferential surface and formed around the entire circumference in a portion on the second side relative to the center in the axial direction. The second engaging portion 45 is formed at a position in the axial direction that corresponds to the first engaging portion 86 formed in the cylindrical portion 81 of the inner housing 80. The clip 22 is fitted into the second engaging portion 45 and the first engaging portion 86.

### (Sleeve 90)

The sleeve 90 is a cylindrical member made of a metallic material such as iron, stainless steel, aluminum, or brass. The inner diameter of the sleeve 90 is smaller than the diameter of the parallel surface 471 defining the recess 47 of the disk-shaped portion 41 of the covering portion 40, and the sleeve 90 is fitted at its second side end onto the disk-shaped portion 41 of the covering portion 40 by interference fit. In other words, the sleeve 90 is press-fitted onto the disk-shaped portion 41 until the second side end face thereof butts against the perpendicular surface 472 defining the recess 47. It should be noted that the manner of joining the sleeve 90 to the covering portion 40 is not limited to press-fitting. For example, other methods such as adhesion or welding may be used.

The inner diameter of the sleeve 90 is larger than or equal to the outer diameter of the second cylindrical portion 72 of the outer housing 70 and smaller than the outer diameter of the third cylindrical portion 73. Hence, when the cover unit 30 is attached to the housing 60, the sleeve 90 has its first side end located outside of the second cylindrical portion 72 of the outer housing 70. In the axial direction, the sleeve 90 is disposed between the perpendicular surface 472 of the covering portion 40 and the inclined surface 75 of the third cylindrical portion 73, which prevents the sleeve 90 from falling off the cover unit 30.

The sleeve 90 includes, at its first side end, an inclined surface 91 that is inclined from the first side end face relative to the axial direction such that the diameter gradually decreases from the first side toward the second side. The sleeve 90 is disposed such that the inclined surface 91 faces the inclined surface 75 of the third cylindrical portion 73. The inclined surface 91 and the inclined surface 75 desirably have the same angle of inclination relative to the axial direction.

The sleeve 90 includes a protruding portion 92 protruding from the first side end face toward the first side. The protruding portion 92 is a rectangular portion formed in a portion of the circumference of the sleeve 90. The circumferential size of the protruding portion 92 is smaller than that of the cutaway portion 731 formed in the third cylindrical portion 73 of the outer housing 70, and the protruding portion 92 is fitted into the cutaway portion 731.

The sleeve 90 includes a recess 93 formed in a portion of the circumference and depressed from the second side end face toward the first side. The circumferential size of the recess 93 is larger than or equal to that of the protrusion 48 of the disk-shaped portion 41 of the cover unit 30, and the protrusion 48 is fitted into the recess 93.

The protruding portion 92 is provided over the region that overlaps the recess 93 in the circumferential direction. In other words, the protruding portion 92 is provided at a position corresponding to the location where the connector portion 32 is provided. This prevents the appearance from being compromised by the provision of the protruding portion 92 in the sleeve 90.

Coating is applied to the sleeve 90. By way of example, the coating may be a cationic electrodeposition coating with high corrosion resistance.

### (Sealing Element 95)

The sealing element 95 is a cylindrical member molded from a rubber-based material, with its centerline extending in the axial direction. Both axial ends of the sealing element 95 are rounded. In other words, the cross-section of both axial ends of the sealing element 95 taken in a plane parallel to the axial direction is of a semicircular shape.

The inner diameter of the sealing element 95 is larger than the outer diameter of the first cylindrical portion 71 of the outer housing 70 and smaller than the outer diameter of the second cylindrical portion 72. The outer diameter of the sealing element 95 is larger than the outer diameter of the second cylindrical portion 72 of the outer housing 70 and smaller than the outer diameter of the third cylindrical portion 73. When the cover unit 30 is attached to the housing 60, the sealing element 95 is sandwiched between the cover unit 30 and the outer housing 70 and contacts the inclined surface 46 of the cover unit 30 and the inclined surface 74 of the second cylindrical portion 72 of the outer housing 70.

Before the sealing element 95 is assembled inside the sleeve 90, the outer diameter of the sealing element 95 is larger than the inner diameter of the sleeve 90. This creates a frictional force between the outer circumferential surface of the sealing element 95 and the inner circumferential surface of the sleeve 90 when the sealing element 95 is assembled inside the sleeve 90. This enables the sealing element 95 to be assembled inside the sleeve 90 before assembling the cover unit 30 and the sleeve 90 onto the housing 60.

As the sealing element 95 is sandwiched in an elastically deformed state between the outer housing 70 and the cover unit 30, the cover unit 30 is subjected to a force acting in the axial direction from the first side toward the second side. In the present embodiment, even if this force acts on the cover unit 30, the clip 22 fitted in the second engaging portion 45 of the cover unit 30 butts against the first engaging portion 86 of the inner housing 80, preventing the cover unit 30 from moving toward the second side.

By way of example, the above configured solenoid 1 may be assembled using the assembling method described below. Specifically, an operator assembles components of the damping force mechanism unit 160, including the orifice plate 161, the pilot valve 162, and the compression coil spring 163, components of the valve unit 10, including the adjustment valve 170, the plunger 12, and the magnetic element 13, as well as the support member 164, the fixed core 21, and other components into the interior of the outer housing 70 secured to the outer circumferential surface of the damper case 113. The operator then tightens the inner housing 80 to the outer housing 70.

Meanwhile, before assembling the cover unit 30 onto the housing 60, the sleeve 90 is fitted onto the cover unit 30, and the sealing element 95 is fitted inside the sleeve 90. Thus, the cover unit 30, the sleeve 90, and the sealing element 95 are assembled as a single unit onto the housing 60. Although the sleeve 90 and the sealing element 95 are joined by fitting the sealing element 95 inside the sleeve 90, other manners of joining the sleeve 90 and the sealing element 95 may be used, such as press-fitting, adhesion, or welding.

To assemble the cover unit 30 onto the housing 60, the operator inserts the peripheral portion 42 into the interior of the inner housing 80 with the clip 22 fitted in the second engaging portion 45 of the peripheral portion 42 of the cover unit 30. With the clip 22 elastically deformed by contact with the inner circumferential surface of the inner housing 80 such that the clip 22 reduces in diameter to be fully embedded in the second engaging portion 45 of the peripheral portion 42, the peripheral portion 42 is inserted into the interior of the inner housing 80. Once the clip 22 is inserted to a position corresponding to the first engaging portion 86 formed in the inner housing 80, the clip 22 increases in diameter, causing its outside portion to fit into the first engaging portion 86. This prevents the cover unit 30 from pulling out of the housing 60 after the cover unit 30 is assembled on the housing 60. In other words, the first side face of the clip 22 butts against the first side face of the second engaging portion 45 and the second side face of the clip 22 butts against the second side face of the first engaging portion 86, which prevents the cover unit 30 from pulling out of the housing 60 even if the cover unit 30 receives from the sealing element 95 a force in the direction away from the housing 60.

The sleeve 90 and the sealing element 95 do not have to be fitted onto the cover unit 30 before assembling the cover unit 30 onto the housing 60. For example, the sleeve 90 may be assembled onto the housing 60 with the sealing element 95 fitted inside the sleeve 90, and then the cover unit 30 may be assembled onto the housing 60 and the sleeve 90. Alternatively, for example, the sleeve 90 may be assembled onto the outside of the sealing element 95 after placing the sealing element 95 on the second side end of the second cylindrical portion 72 of the outer housing 70, and then the cover unit 30 may be assembled onto the housing 60 and the sleeve 90.

The solenoid 1 described above includes: the covering portion 40 (an example of the first member) including the peripheral portion 42 to cover the periphery of the coil 31, which is contained in the cylindrical housing 60, and covering the opening 61 of the housing 60; and the disassemblable sleeve 90 (an example of the second member) provided around the outer periphery of the covering portion 40. The solenoid 1 further includes the sealing element 95 disposed inside the sleeve 90 to prevent foreign matters from entering the housing 60.

In the above configured the solenoid 1, the sealing element 95 seals the gap between the covering portion 40 and the housing 60, thereby preventing foreign matters from entering the housing 60. In addition, since the sealing element 95 is disposed inside the sleeve 90, it can be prevented from being damaged or deteriorated by flying stones etc. In particular, the sleeve 90 is molded from a metallic material, which provides high strength and durability. The above configuration, where the sleeve 90 is fitted onto the covering portion 40, allows for easier production as compared to, for example, a configuration (which may be referred to hereinafter as the “comparative configuration”) where an object corresponding to the covering portion 40 is molded in a primary mold and another object corresponding to the sleeve 90 is molded in a secondary mold using resin and the two objects are joined together. This is because the comparative configuration would require complex molds and difficult control of weld lines, sink marks, etc. in the manufacturing processes. In addition, since the connector portion 32 is located outside of the object corresponding to the sleeve 90, for example, it would be difficult for the comparative configuration to achieve miniaturization due to the division of the mold. Also, the comparative configuration may suffer from reduced sealing between the two parts due to the parting line created in the portion at which the mold is divided. In contrast, in the case of the solenoid 1, for example, only the cover unit 30 can be molded in a mold using resin, which facilitates miniaturization. In addition, in the case of the solenoid 1, no parting lines are created on the sleeve 90, which provides improved sealing between the covering portion 40 and the sleeve 90 over the comparative configuration.

The outer housing 70 is made of metal, and coating is applied to at least portions thereof outside the contacting portion with the sealing element 95, such as the inclined surface 75 and outer circumferential surface of the third cylindrical portion 73. This prevents the outer housing 70 from rusting. Similarly, the sleeve 90 is made of metal and coating is applied thereto, preventing it from rusting. Furthermore, the coating is a cationic electrodeposition coating, which provides greater corrosion resistance than, e.g., plating.

The sleeve 90 includes the protruding portion 92 as an example of the restraining portion that restrains the sleeve 90 from rotating about the centerline of the housing 60 relative to the housing 60. The sleeve 90 is restrained from rotating relative to the housing 60 as the protruding portion 92 is fitted into the cutaway portion 731 formed in the outer housing 70.

The cover unit 30 is restrained from rotating relative to the sleeve 90 and housing 60 as the protrusion 48 provided on the disk-shaped portion 41 is fitted into the recess 93 formed in the sleeve 90. However, the manner in which the cover unit 30 is restrained from rotating relative to the sleeve 90 and the housing 60 is not limited. For example, the sleeve 90 may include a protruding portion protruding toward the second side from a circumferential portion of its second side end face, and the disk-shaped portion 41 of the cover unit 30 may be formed with a recess to receive the protruding portion.

The sealing element 95 contacts the inclined surface 46 of the cover unit 30 and the inclined surface 74 of the outer housing 70, which leads to a larger contact area between the inclined surfaces 46 and 74 and the sealing element 95 as compared to when, for example, the sealing element 95 contacts surfaces parallel to or perpendicular to the axial direction. As a result, the solenoid 1 provides improved sealing of the gap between the cover unit 30 and the housing 60, which in turn provides improved reliability of the sealing structure within the housing 60.

The outer housing 70 includes the first cylindrical portion 71, and the sealing element 95 is disposed outside the first cylindrical portion 71. This configuration allows for easier assembly of the sealing element 95 onto the outer housing 70. However, the outer housing 70 may not be provided with the first cylindrical portion 71. By reducing the gap between the outer circumferential surface of the inner housing 80 and the inner circumferential surface of the sealing element 95 by the omission of the first cylindrical portion 71, the radial size of the solenoid 1 can be reduced.

When assembling the cover unit 30, the sleeve 90, and the sealing element 95 onto the housing 60, the peripheral portion 42 may be inserted into the housing 60 with the sleeve 90 fitted on the outer periphery of the covering portion 40 and with the sealing element 95 disposed inside the sleeve 90. In this way, the cover unit 30, the sleeve 90, and the sealing element 95 can be pre-assembled and then assembled onto the housing 60, providing the same ease of assembly as in the comparative configuration.

### <Second Embodiment>

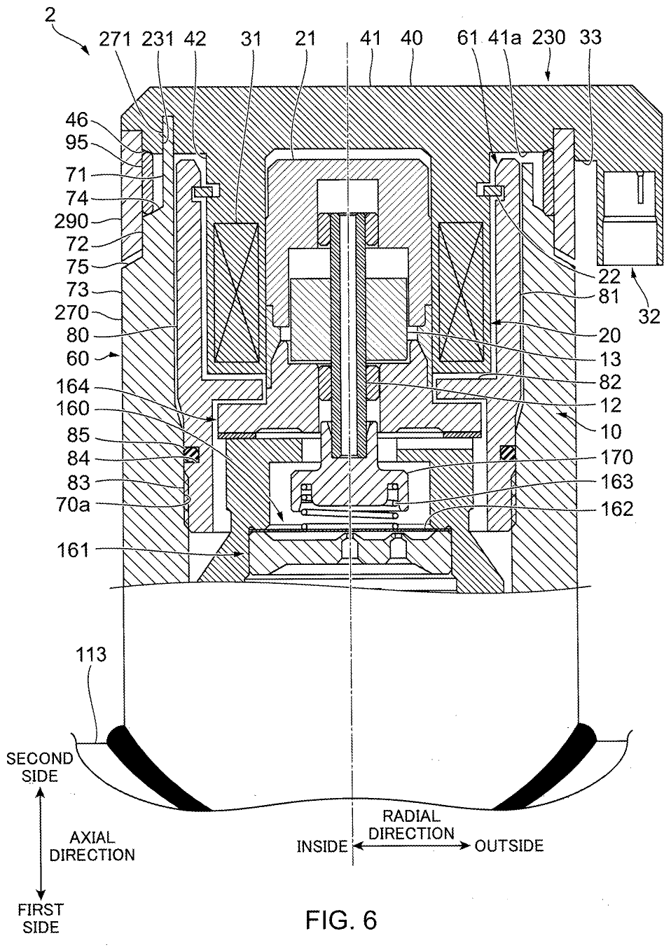

FIG. 6 illustrates an example schematic configuration of a solenoid 2 according to a second embodiment.

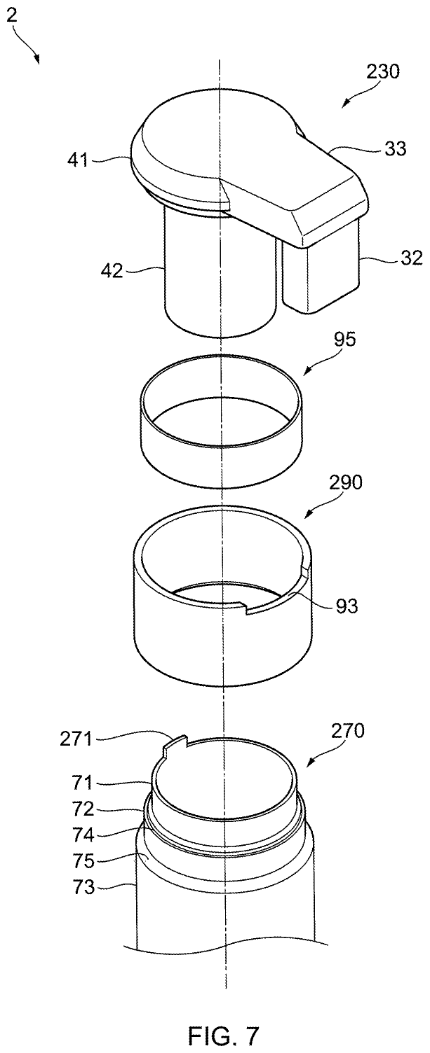

FIG. 7 is a perspective view of components of the solenoid 2 according to the second embodiment, as viewed obliquely from the second side.

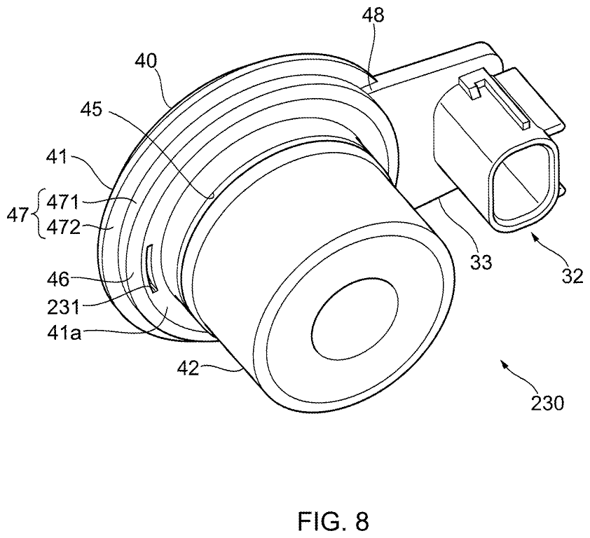

FIG. 8 is a perspective view of the components of the solenoid 2 according to the second embodiment, as viewed obliquely from the first side.

Distinctions of the solenoid 2 according to the second embodiment from the solenoid 1 according to the first embodiment relate to an outer housing 270, a cover unit 230, and a sleeve 290, which correspond to the outer housing 70, the cover unit 30, and the sleeve 90, respectively. Another distinction of the solenoid 2 from the solenoid 1 relates to the manner in which the cover unit 230 is restrained from rotating relative to the outer housing 270. The distinctions from the first embodiment are described below. The same reference numerals are used to identify the same elements in the first and second embodiments, and detailed descriptions thereof are omitted.

In a distinction from the outer housing 70, the outer housing 270 includes a protrusion 271 protruding toward the second side from the second side end of the first cylindrical portion 71. The protrusion 271 is formed at a portion of the circumference.

In another distinction from the outer housing 70, the outer housing 270 is not formed with the cutaway portion 731.

In a distinction from the cover unit 30, the cover unit 230 is formed with a recess 231 depressed from the end face 41a of the disk-shaped portion 41 toward the second side. The recess 231 is formed in a portion of the circumference. The circumferential size of the recess 231 is larger than or equal to that of the protrusion 271 of the outer housing 270, and the protrusion 271 is fitted into the recess 231. With this fitting of the protrusion 271 into the recess 231, the cover unit 230 is restrained from rotating relative to the outer housing 270.

As shown in FIGS. 7 and 8, the recess 231 and the protrusion 271 are provided at positions that are circumferentially displaced 180 degrees relative to the junction 33. However, the recess 231 and the protrusion 271 are not limited to being provided at positions that are circumferentially displaced 180 degrees relative to the junction 33.

In a distinction from the sleeve 90, the sleeve 290 is not formed with the protruding portion 92. Similarly to the sleeve 90, the sleeve 290 is restrained from rotating relative to the cover unit 230 as the protrusion 48 of the cover unit 230 is fitted into the recess 93.

The sleeve 290 is press-fitted onto the disk-shaped portion 41 of the cover unit 230, which prevents it from falling off the cover unit 230. Hence, the diameter of the outermost circumferential surface of the outer housing 270 may be smaller than the diameter of the inner circumferential surface of the sleeve 290. In other words, the outer housing 270 may have the second cylindrical portion 72 extend to the damper case 113 without the third cylindrical portion 73. In such a configuration where the second cylindrical portion 72 extends to the damper case 113, for example, a metal ring may be attached to the outer circumferential surface of the second cylindrical portion 72, which is the outermost circumferential surface of the outer housing 270, and the first side end of the sleeve 290 or the inner circumferential surface of the sleeve 290 may be brought into contact with the ring to prevent the sleeve 290 from falling off.

### <Third Embodiment>

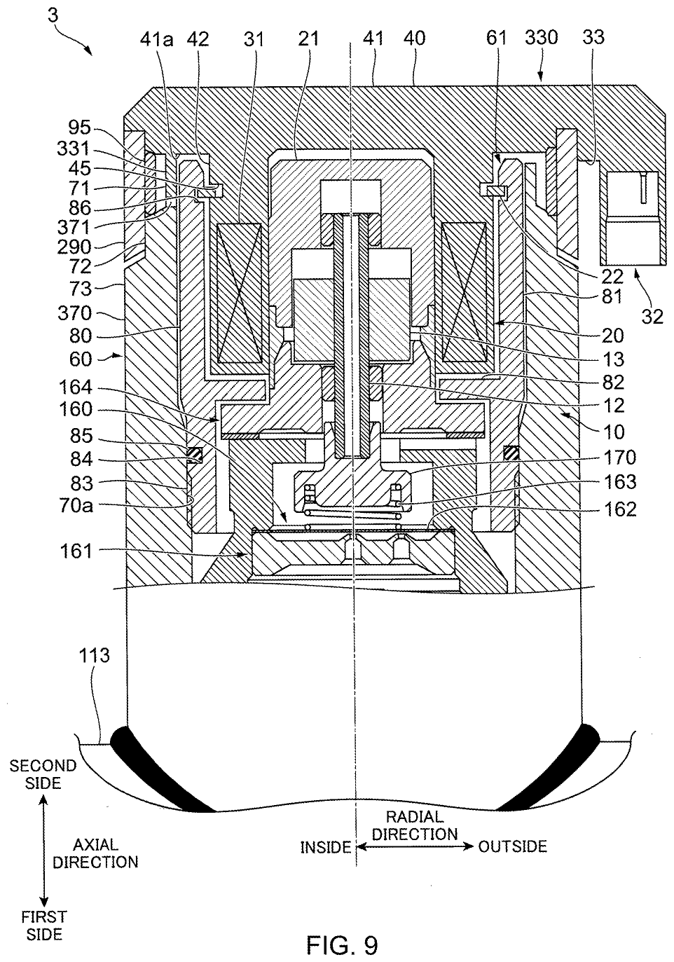

FIG. 9 illustrates an example schematic configuration of a solenoid 3 according to a third embodiment.

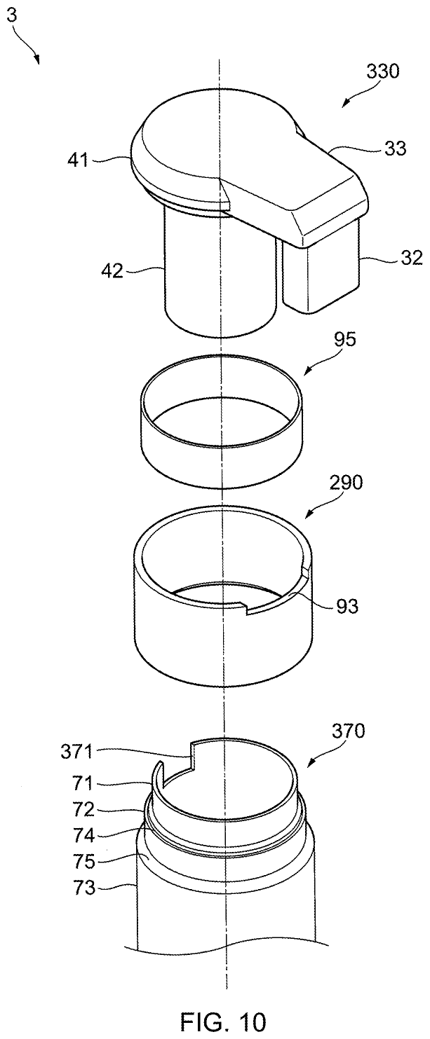

FIG. 10 is a perspective view of components of the solenoid 3 according to the third embodiment, as viewed obliquely from the second side.

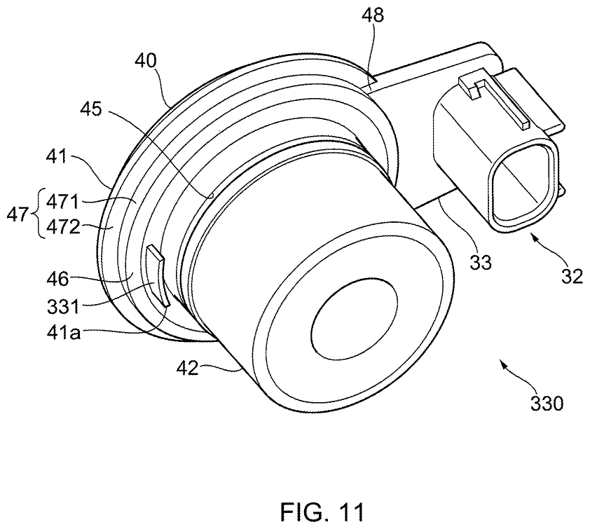

FIG. 11 is a perspective view of the components of the solenoid 3 according to the third embodiment, as viewed obliquely from the first side.

Distinctions of the solenoid 3 according to the third embodiment from the solenoid 2 according to the second embodiment relate to an outer housing 370 and a cover unit 330, which correspond to the outer housing 270 and the cover unit 230, respectively. Another distinction of the solenoid 3 from the solenoid 2 relates to the manner in which the cover unit 330 is restrained from rotating relative to the outer housing 370. The distinctions from the second embodiment are described below. The same reference numerals are used to identify the same elements in the second and third embodiments, and detailed descriptions thereof are omitted.

In a distinction from the outer housing 270, the outer housing 370 does not include the protrusion 271. In another distinction from the outer housing 270, the outer housing 370 is formed with a recess 371 depressed from the second side end toward the first side. The recess 371 is formed in a portion of the circumference.

In a distinction from the cover unit 230, the cover unit 330 is not formed with the recess 231. In another distinction from the cover unit 230, the cover unit 330 includes a protrusion 331 protruding toward the first side from the end face 41a of the disk-shaped portion 41. The protrusion 331 is formed in a portion of the circumference. The circumferential size of the protrusion 331 is smaller than or equal to that of the recess 371 of the outer housing 370, and the protrusion 331 is fitted into the recess 371. With this fitting of the protrusion 331 into the recess 371, the cover unit 330 is restrained from rotating relative to the outer housing 370.

As shown in FIGS. 10 and 11, the protrusion 331 and the recess 371 are provided at positions that are circumferentially displaced 180 degrees relative to the junction 33. However, the protrusion 331 and the recess 371 are not limited to being provided at positions that are circumferentially displaced 180 degrees relative to the junction 33.

### <Fourth Embodiment>

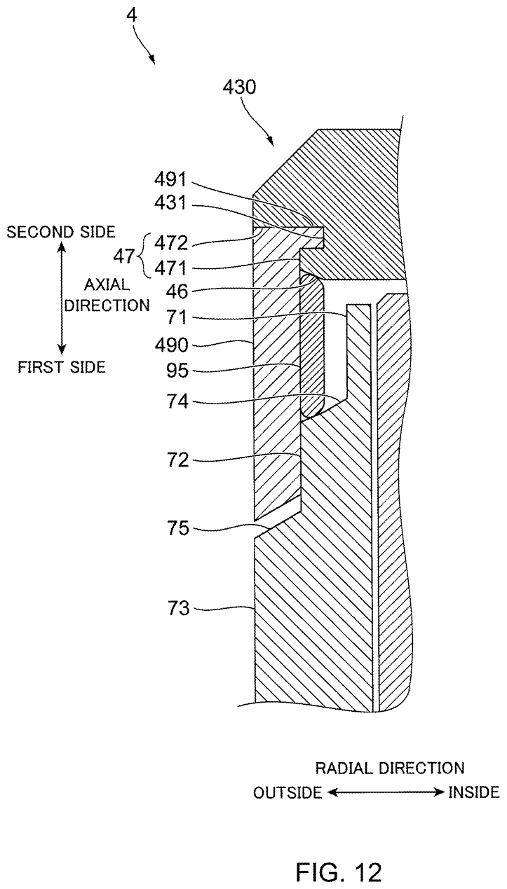

FIG. 12 illustrates an example schematic configuration of a solenoid 4 according to a fourth embodiment.

Distinctions of the solenoid 4 according to the fourth embodiment from the solenoid 2 according to the second embodiment relate to a cover unit 430 and a sleeve 490, which correspond to the cover unit 230 and the sleeve 290, respectively. The distinctions from the second embodiment are described below. The same reference numerals are used to identify the same elements in the second and fourth embodiments, and detailed descriptions thereof are omitted.

A distinction of the solenoid 4 from the solenoid 2 relates to the manner in which the cover unit 430 and the sleeve 490 are coupled.

More specifically, the cover unit 430 differs from the cover unit 230 in that the cover unit 430 includes a groove 431 depressed inward from the parallel surface 471 and formed at the second side end of the recess 47 provided on the outer periphery.

In a distinction from the sleeve 290, the sleeve 490 includes a protruding portion 491 protruding inward from the second side end. The manner in which the protruding portion 491 is formed is not limited. By way of example, the protruding portion 491 may be formed by bending or cutting.

The above configured cover unit 430 and sleeve 490 are coupled by fitting the protruding portion 491 of the sleeve 490 into the groove 431 of the cover unit 430. By way of example, the cover unit 430 may be elastically deformed to allow for fitting of the protruding portion 491 into the groove 431. This allows the cover unit 430 and the sleeve 490 to be assembled onto the outer housing 270 after being firmly integrated.

The groove 431 of the cover unit 430 and the protruding portion 491 of the sleeve 490 may be provided over the entire circumference or in portions of the circumference. When they are provided in portions of the circumference, more than one grooves 431 and more than one protruding portions 491 may be provided in the circumference.

The above manner of coupling the cover unit 430 and the sleeve 490 may be applied to the solenoid 1 according to the first embodiment or the solenoid 3 according to the third embodiment.

The axial position and shape of the groove 431 of the cover unit 430 and the protruding portion 491 of the sleeve 490 are not limited.

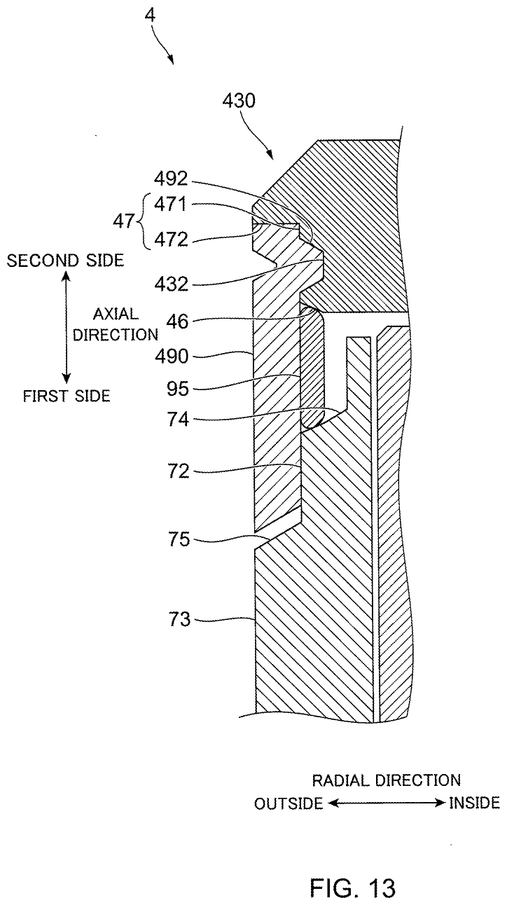

FIG. 13 illustrates example variations of the cover unit 430 and the sleeve 490.

As shown in FIG. 13, a groove 432 may be formed in the axial center of the parallel surface 471. Thus, a protruding portion 492 may be provided in a portion on the first side relative to the second side end and fitted into the groove 432. By way of example, the protruding portion 492 may be formed by stamping.

The groove 432 and the protruding portion 492 may be provided over the entire circumference or in portions of the circumference. When they are provided in portions of the circumference, more than one grooves 432 and more than one protruding portions 492 may be provided in the circumference.

### <Fifth Embodiment>

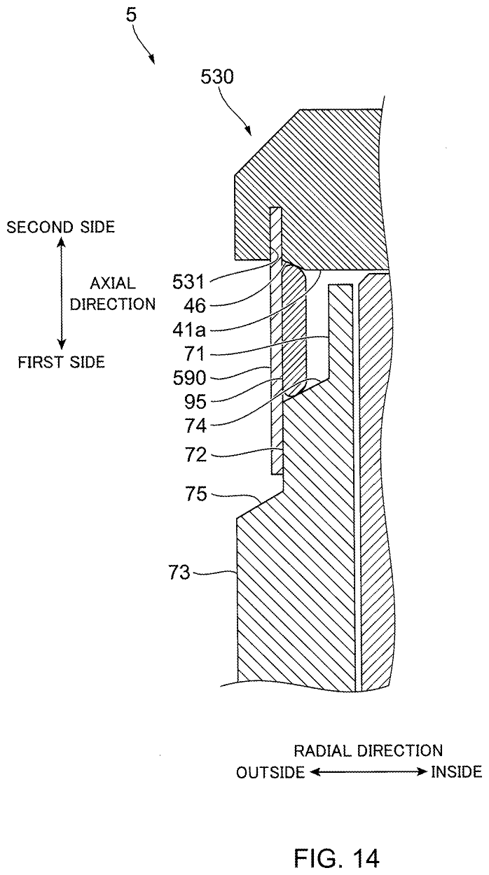

FIG. 14 illustrates an example schematic configuration of a solenoid 5 according to a fifth embodiment.

Distinctions of the solenoid 5 according to the fifth embodiment from the solenoid 2 according to the second embodiment relate to a cover unit 530 and a sleeve 590, which correspond to the cover unit 230 and the sleeve 290, respectively. The distinctions from the second embodiment are described below. The same reference numerals are used to identify the same elements in the second and fifth embodiments, and detailed descriptions thereof are omitted.

A distinction of the solenoid 5 from the solenoid 2 relates to the manner in which the cover unit 530 and the sleeve 590 are coupled.

More specifically, the cover unit 530 differs from the cover unit 230 in that the cover unit 530 does not include the recess 47 on the outer periphery. The cover unit 530 includes a groove 531 formed outside of the inclined surface 46 and inside of the outermost periphery and depressed from the end face 41a toward the second side.

The sleeve 590 is a cylindrical member. The radial size, or the wall thickness, of the sleeve 590 is larger than the radial size of the groove 531 of the cover unit 530. The sleeve 590 has its second side end fitted into the groove 531 of the cover unit 530. In other words, the second side end of the sleeve 590 is press-fitted into the groove 531 of the cover unit 530, so that the inner and outer circumferential surfaces of the sleeve 590 are brought into contact with respective radial surfaces of the groove 531 of the cover unit 530.

With this configuration where the sleeve 590 is press-fitted into the groove 531 of the cover unit 530 and brought into contact on its inner and outer circumferential surfaces with the respective surfaces of the groove 531 to thereby hold the sleeve 590 in the cover unit 530, the rigidity of the sleeve 590 can be made smaller than that of the sleeve 290. Thus, the wall thickness of the sleeve 590 can be smaller than that of the sleeve 290, which helps reduce the weight of the solenoid 5.

Before inserting the sleeve 590 into the groove 531 of the cover unit 530, an adhesive may be applied to the second side end of the sleeve 590 or filled in the groove 531. This prevents the sleeve 590 from falling off the cover unit 530.

Knurling may be applied to at least one of the inner and outer circumferential surfaces of the second side end of the sleeve 590 to form an uneven surface. This prevents the sleeve 590 from falling off the cover unit 530.

The above manner of coupling the cover unit 530 and the sleeve 590 may be applied to the solenoid 1 according to the first embodiment or the solenoid 3 according to the third embodiment.

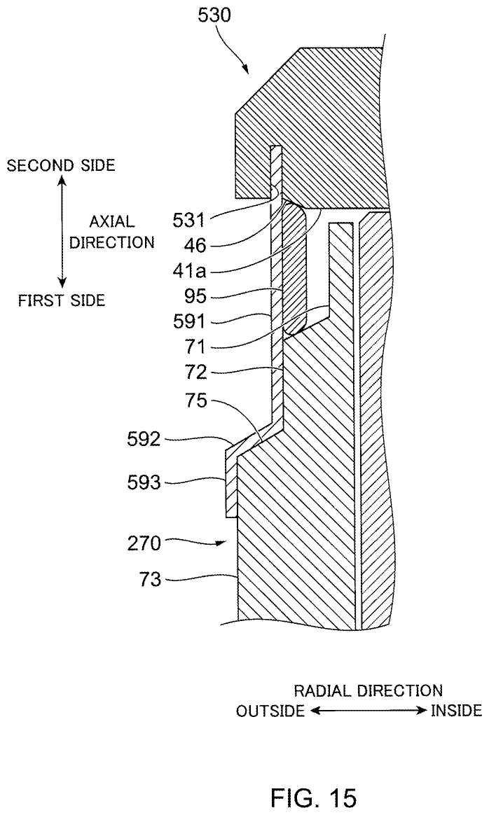

FIG. 15 illustrates a schematic configuration of a sleeve 591 according to a first variation.

As shown in FIG. 15, the sleeve 591 may include an inclined portion 592 and a parallel portion 593 provided so to cover the second side end of the third cylindrical portion 73, where the inclined portion 592 is inclined relative to the axial direction and faces the inclined surface 75, and the parallel portion 593 extends parallel to the axial direction from the first side end of the inclined portion 592.

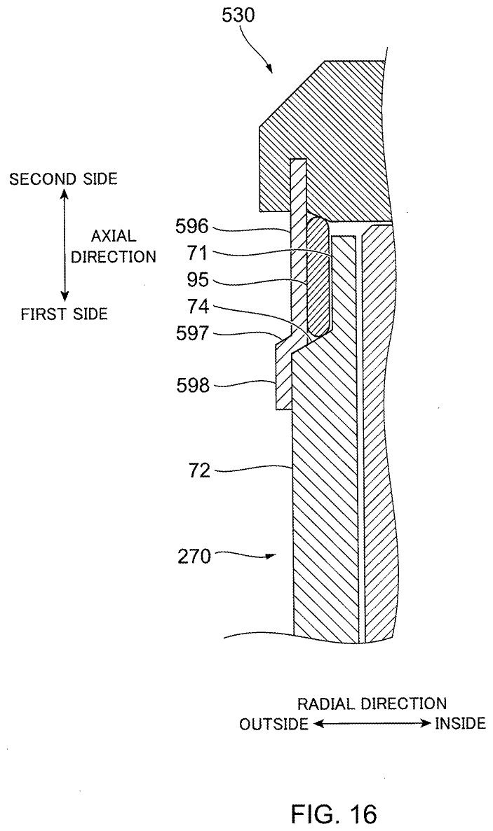

FIG. 16 illustrates a schematic configuration of a sleeve 596 according to a second variation.

As shown in FIG. 16, when the outer housing 270 does not include the third cylindrical portion 73 and has the second cylindrical portion 72 extend to the damper case 113, the sleeve 596 may include an inclined portion 597 and a parallel portion 598 provided so as to cover the second side end of the second cylindrical portion 72, where the inclined portion 597 is inclined relative to the axial direction and faces the inclined surface 74, and the parallel portion 598 extends parallel to the axial direction from the first side end of the inclined portion 597. The radial size, or the wall thickness, of the sealing element 95 is not limited. The wall thickness of the sealing element 95 may be set in accordance with the radial size of the space between the sleeve 596 and the first cylindrical portion 71, in which the sealing element 95 is to be disposed.

### <Sixth Embodiment>

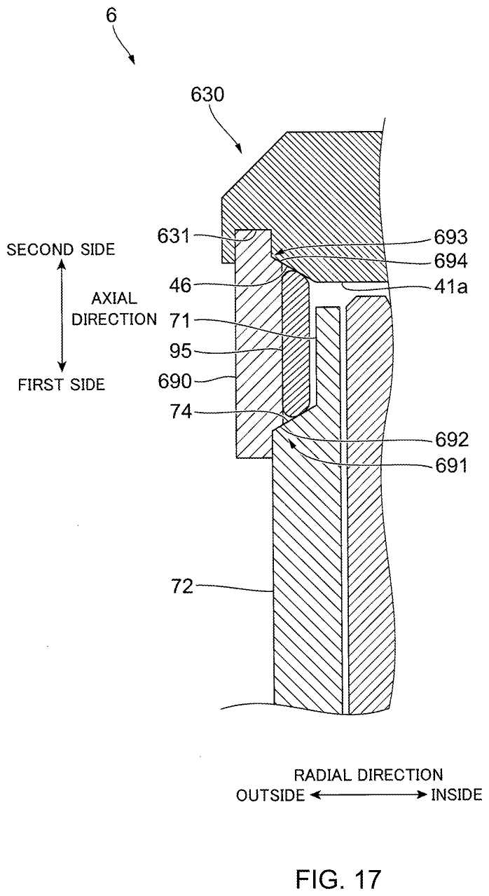

FIG. 17 illustrates an example schematic configuration of a solenoid 6 according to a sixth embodiment.

Distinctions of the solenoid 6 according to the sixth embodiment from the solenoid 2 according to the second embodiment relate to a cover unit 630 and a sleeve 690, which correspond to the cover unit 230 and the sleeve 290, respectively. The distinctions from the second embodiment are described below. The same reference numerals are used to identify the same elements in the second and sixth embodiments, and detailed descriptions thereof are omitted.

Unlike the sleeve 290, the sleeve 690 is molded from a resin-based material. The sleeve 690 is a molded resin product molded using a mold, separately from the cover unit 630, and is a separate component from the cover unit 630.

The sleeve 690 is a cylindrical member. The sleeve 690 includes a recess 691 formed at an inner portion of its first side end and depressed from its first side end face and inner circumferential surface. The first side inner surface of the sleeve 690 defining the recess 691 is an inclined surface 692 that corresponds to the inclined surface 74 of the outer housing 70. The sleeve 690 further includes a recess 693 formed at an inner portion of its second side end and depressed from its second side end face and inner circumferential surface. The second side inner surface of the sleeve 690 defining the recess 693 is an inclined surface 694 that corresponds to the inclined surface 46 of the cover unit 630.

In a distinction from the cover unit 230, the cover unit 630 does not include the recess 47 on the outer periphery. Instead, the cover unit 630 includes a groove 631 formed outside of the inclined surface 46 and inside of the outermost periphery and depressed from the end face 41a toward the second side.

With the sleeve 690 and the cover unit 630 configured as above, the sleeve 690 is mounted between the cover unit 630 and the outer housing 270. The sleeve 690 may be configured to press-fit onto the cover unit 630, so that the sleeve 690 and the cover unit 630 may be integrated before being assembled onto the outer housing 270. Alternatively, the sleeve 690 may not be configured to press-fit onto the cover unit 630, so that the sleeve 690 may be assembled onto the outer housing 270 prior to assembling the cover unit 630 thereon and then the cover unit 630 may be assembled.

In the case of the solenoid 6, too, the sealing element 95 is disposed inside the sleeve 690 and thus prevented from being damaged or deteriorated by flying stones etc. In addition, the sleeve 690 and the cover unit 630 are separate components, and the sleeve 690 is fitted onto the cover unit 630 after both components are molded separately and independently. Therefore, the solenoid 6 can also be produced easily and reduced in size compared to the comparative configuration.

While FIG. 17 shows the configuration where the outer housing 270 does not include the third cylindrical portion 73 and the second cylindrical portion 72 extends to the damper case 113, the shape of the outer housing 270 is not limited. Also, the sleeve 690 and the cover unit 630 may be applied to the solenoid 1 according to the first embodiment or the solenoid 3 according to the third embodiment.

### <Seventh Embodiment>

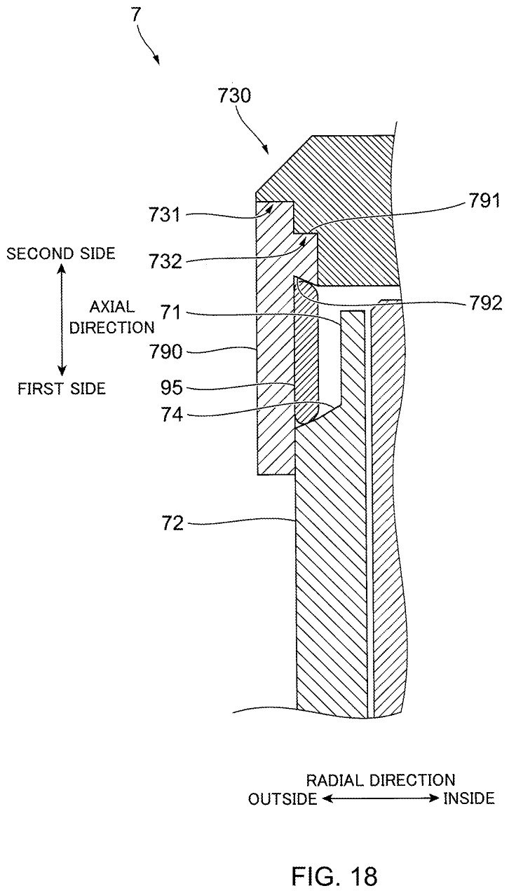

FIG. 18 illustrates an example schematic configuration of a solenoid 7 according to a seventh embodiment.

Distinctions of the solenoid 7 according to the seventh embodiment from the solenoid 6 according to the sixth embodiment relate to a cover unit 730 and a sleeve 790, which correspond to the cover unit 630 and the sleeve 690, respectively. The distinctions from the sixth embodiment are described below. The same reference numerals are used to identify the same elements in the sixth and seventh embodiments, and detailed descriptions thereof are omitted.

The solenoid 7 differs from the solenoid 6 in that the sealing element 95 is sandwiched between the sleeve 790 and the outer housing 270, and the cover unit 730 covers the second side end of the sleeve 790.

The sleeve 790 is a cylindrical member and is provided with a protruding portion 791 protruding inwardly from the inner circumferential surface at a portion on the second side relative to the center in the axial direction. The protruding portion 791 is of a cylindrical shape, and its first side end face is defined by an inclined surface 792 that is inclined relative to the axial direction such that the diameter gradually increases from the first side toward the second side.

As with the sleeve 690, the sleeve 790 is molded from a resin-based material. The sleeve 790 is a molded resin product molded using a mold, separately from the cover unit 730, and is a separate component from the cover unit 730.

In a distinction from the cover unit 630, the cover unit 730 is not formed with the inclined surface 46 and the groove 631. The cover unit 730 is formed on its outer periphery with a recess 731 to receive the second side end of the sleeve 790 and a recess 732 to receive the protruding portion 791 of the sleeve 790.

With the sleeve 790 and the cover unit 730 configured as above, the sleeve 790 and the outer housing 270 sandwich the sealing element 95, and the cover unit 730 covers the second side end of the sleeve 790. The sleeve 790 may be configured to press-fit onto the cover unit 730, so that the sleeve 790 and the cover unit 730 may be integrated before being assembled onto the outer housing 270. Alternatively, the sleeve 790 may not be configured to press-fit onto the cover unit 730, so that the sleeve 790 may be assembled onto the outer housing 270 prior to assembling the cover unit 730 thereon and then the cover unit 730 may be assembled.

In the case of the solenoid 7, too, the sealing element 95 is disposed inside the outer periphery of the sleeve 790 and thus prevented from being damaged or deteriorated by flying stones etc. In addition, the sleeve 790 and the cover unit 730 are separate components, and the sleeve 790 is fitted onto the cover unit 730 after both components are molded separately and independently. Therefore, the solenoid 7 can also be produced easily and reduced in size compared to the comparative configuration.

While FIG. 18 shows the configuration where the outer housing 270 does not include the third cylindrical portion 73 and the second cylindrical portion 72 extends to the damper case 113, the shape of the outer housing 270 is not limited. Also, the sleeve 790 and the cover unit 730 may be applied to the solenoid 1 according to the first embodiment or the solenoid 3 according to the third embodiment.

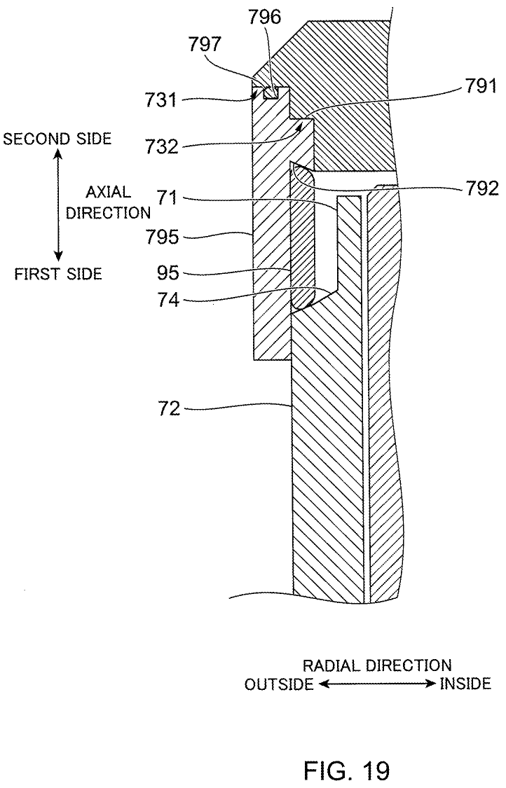

FIG. 19 illustrates a schematic configuration of a sleeve 795 according to a first variation.

Unlike the sleeve 790, the sleeve 795 is formed with a groove 796 depressed from the second side end face, as shown in FIG. 19. An elastic O-ring 797 is fitted into the groove 796 to seal a space between the sleeve 795 and the cover unit 730. This enhances sealing between the sleeve 795 and the cover unit 730 even if, for example, the sleeve 795 is not press-fitted onto the cover unit 730.

### <Eighth Embodiment>

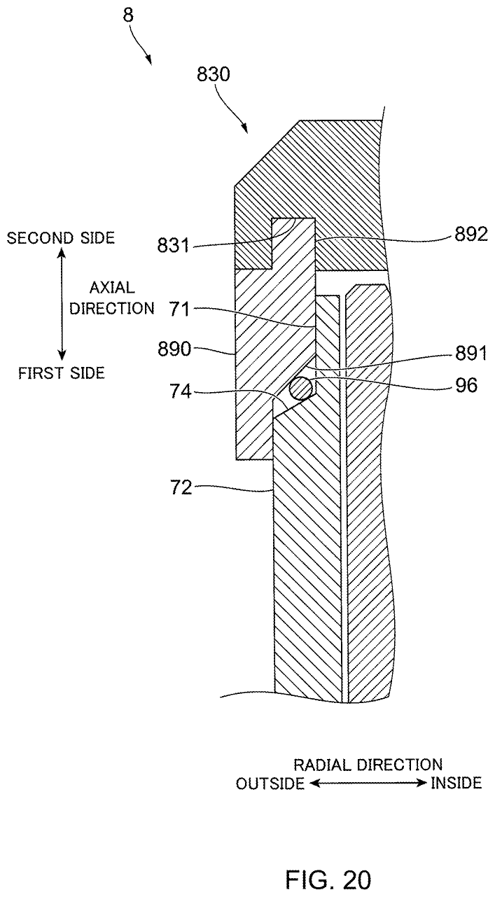

FIG. 20 illustrates an example schematic configuration of a solenoid 8 according to an eighth embodiment.

Distinctions of the solenoid 8 according to the eighth embodiment from the solenoid 7 according to the seventh embodiment relate to a cover unit 830 and a sleeve 890, which correspond to the cover unit 730 and the sleeve 790, respectively. Another distinction of the solenoid 8 from the solenoid 7 is that the solenoid 8 includes an elastic O-ring 96 instead of the sealing element 95. The distinctions from the seventh embodiment are described below. The same reference numerals are used to identify the same elements in the seventh and eighth embodiments, and detailed descriptions thereof are omitted.

The sleeve 890 is a cylindrical member and includes an inclined surface 891 formed at a portion on the first side relative to the center in the axial direction. The inclined surface 891 is inclined relative to the axial direction such that the diameter gradually increases from the second side toward the first side. The inclined surface 891 and the inclined surface 74 of the outer housing 270 sandwich the O-ring 96.

The sleeve 890 further includes a protruding portion 892 protruding cylindrically from the second side end face toward the second side.

In a distinction from the cover unit 730, the cover unit 830 is not formed with the recess 731 and the recess 732. The cover unit 830 is formed, at a portion inside the outer periphery, with a groove 831 to receive the protruding portion 892 of the sleeve 890.

With the sleeve 890 and the cover unit 830 configured as above, the sleeve 890 and the outer housing 270 sandwich the O-ring 96, and the cover unit 830 covers the second side end of the sleeve 890. The sleeve 890 may be configured to press-fit onto the cover unit 830, so that the sleeve 890 and the cover unit 830 may be integrated before being assembled onto the outer housing 270. Alternatively, the sleeve 890 may not be configured to press-fit onto the cover unit 830, so that the sleeve 890 may be assembled onto the outer housing 270 prior to assembling the cover unit 830 thereon and then the cover unit 830 may be assembled.

In the case of the solenoid 8, too, the O-ring 96 is disposed inside the outer periphery of the sleeve 890 and thus prevented from being damaged or deteriorated by flying stones etc. In addition, the sleeve 890 and the cover unit 830 are separate components, and the sleeve 890 is fitted onto the cover unit 830 after both components are molded separately and independently. Therefore, the solenoid 8 can also be produced easily and reduced in size compared to the comparative configuration.

While FIG. 20 shows the configuration where the outer housing 270 does not include the third cylindrical portion 73 and the second cylindrical portion 72 extends to the damper case 113, the shape of the outer housing 270 is not limited. Also, the sleeve 890, the cover unit 830, and the O-ring 96 may be applied to the solenoid 1 according to the first embodiment or the solenoid 3 according to the third embodiment.

### <Ninth Embodiment>

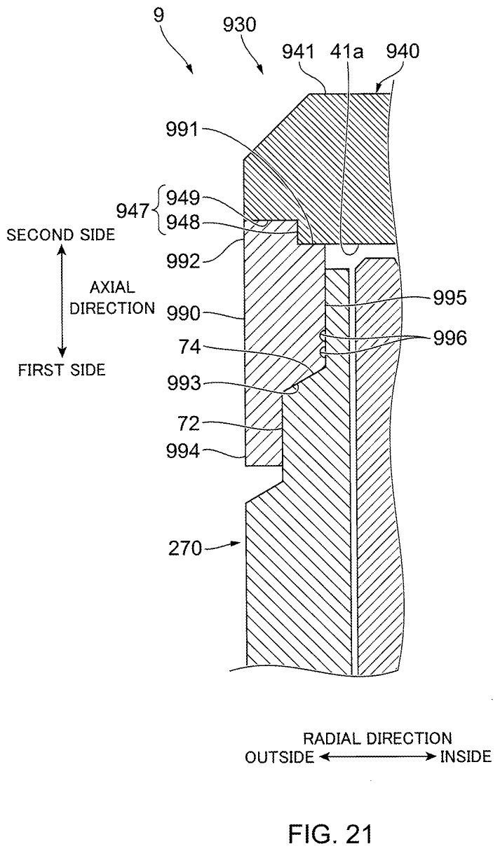

FIG. 21 illustrates an example schematic configuration of a solenoid 9 according to a ninth embodiment.

In a distinction from the solenoid 2 according to the second embodiment, the solenoid 9 according to the ninth embodiment does not include the sleeve 290 and the sealing element 95 and, instead of the sleeve 290 and the sealing element 95, includes a sleeve 990. Another distinction of the solenoid 9 relates to a cover unit 930, which corresponds to the cover unit 230. The distinctions from the second embodiment are described below. The same reference numerals are used to identify the same elements in the second and ninth embodiments, and detailed descriptions thereof are omitted.

A distinction of the cover unit 930 from the cover unit 230 relates to a covering portion 940, which corresponds to the covering portion 40. A distinction of the covering portion 940 from the covering portion 40 relates to a disk-shaped portion 941, which corresponds to the disk-shaped portion 41. The disk-shaped portion 941 is formed on its outer periphery with a recess 947 depressed from the end face 41a. The recess 947 is formed over the entire circumference and defined by a parallel surface 948 parallel to the axial direction and a perpendicular surface 949 perpendicular to the axial direction.

The sleeve 990 is a cylindrical member molded from a rubber-based material, with its centerline extending in the axial direction.

The sleeve 990 includes, on its outer periphery at the second side end, a protrusion 992 protruding from a second side end face 991 toward the second side. The protrusion 992 is a cylindrically protruding portion, and the diameter of its inner circumferential surface is smaller than the diameter of the parallel surface 948 of the cover unit 930. The sleeve 990 is press-fitted onto the cover unit 930 as the protrusion 992 is fitted onto the recess 947 of the cover unit 930 by interference fit.

The sleeve 990 includes, on its outer periphery at the first side end, a protrusion 994 protruding from a first side end surface 993 toward the first side. The protrusion 994 is a cylindrically protruding portion and covers the outer circumferential surface of the second side end of the second cylindrical portion 72 of the outer housing 270.

The sleeve 990 further includes, on its inner periphery at the first side end, two recesses 996 depressed from an inner circumferential surface 995. The recesses 996 have a semicircular cross-section when taken in a plane parallel to the axial direction, and are formed over the entire circumference.

With the cover unit 930 mounted on the housing 60, the sleeve 990 is elastically deformed by being sandwiched between the cover unit 930 and the outer housing 270 and contacts the end face 41a and the perpendicular surface 949 of the cover unit 930 and the inclined surface 74 of the second cylindrical portion 72 of the outer housing 270. The recesses 996 are formed to facilitate elastic deformation of the first side end of the sleeve 990.

As the sleeve 990 is sandwiched in an elastically deformed state between the cover unit 930 and the outer housing 270, the cover unit 930 is subjected to a force acting in the axial direction from the first side toward the second side. However, the clip 22 restrains it from moving toward the second side.

The solenoid 9 described above includes: the covering portion 940 (an example of the first member) including the peripheral portion 42 to cover the coil 31 and the periphery of the coil 31, which is contained in the cylindrical housing 60, and covering the opening 61 of the housing 60; and the elastic cylindrical sleeve 990 (an example of the second member) provided around the outer periphery of the covering portion 940 in a disassemblable manner, the sleeve 990 being configured to prevent foreign matters from entering the housing 60.

In the above configured the solenoid 9, the sleeve 990 seals the gap between the covering portion 940 and the housing 60, thereby preventing foreign matters from entering the housing 60. Additionally, the above configuration, where the sleeve 990 is fitted onto the covering portion 940, allows for easier production and reduced size as compared to, for example, the comparative configuration.

The sleeve 990 is molded from a rubber-based material and sandwiched between the covering portion 940 and the housing 60. This allows the sleeve 990 to be press-fitted onto the covering portion 940, improving sealing between the sleeve 990 and the covering portion 940 and between the sleeve 990 and the housing 60. Additionally, the sleeve 990 can be assembled onto the housing 60 while being in a press-fit relationship with the covering portion 940. Thus, the solenoid 9 provides the same ease of assembly as in the comparative configuration.

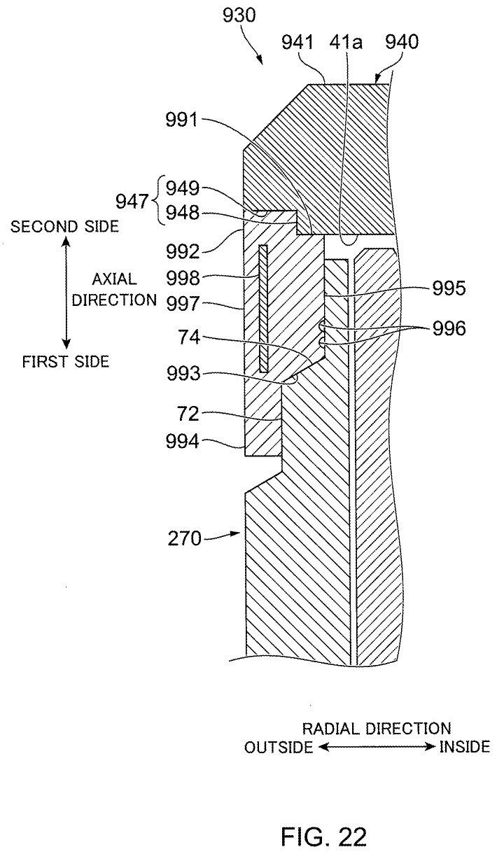

FIG. 22 illustrates an example sleeve 997 according to a variation.

As shown in FIG. 22, the sleeve 997 may include a metal core 998 within the sleeve 997. By way of example, the metal core 998 may be located at the center in the radial and axial directions and have a cylindrical shape with the centerline extending in the axial direction. By virtue of having the metal core 998, the sleeve 997 can have increased rigidity in the axial direction, which makes it less likely to collapse even when sandwiched between the cover unit 930 and the housing 60, thereby improving sealing. It should be noted that the location of the metal core 998 is not limited to the interior of the sleeve 997. For example, the metal core 998 may be disposed on the outer or inner circumferential surface of the sleeve 997.

### <Tenth Embodiment>

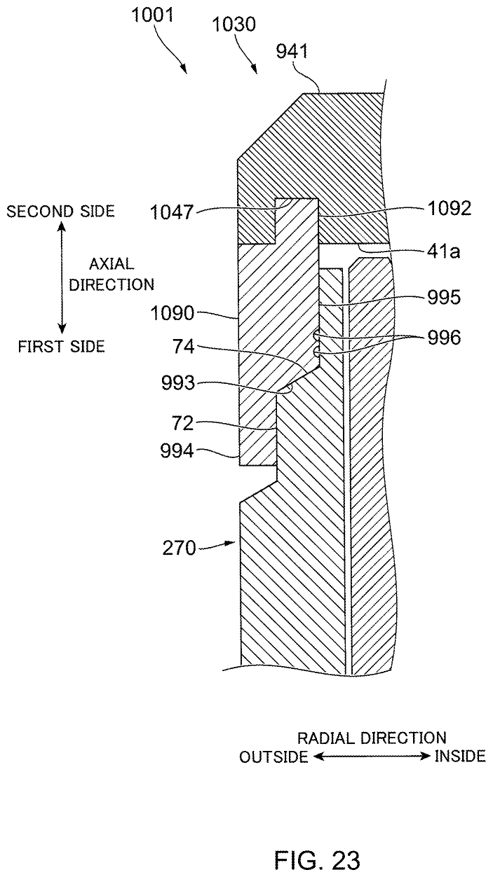

FIG. 23 illustrates an example schematic configuration of a solenoid 1001 according to a tenth embodiment.

Distinctions of the solenoid 1001 according to the tenth embodiment from the solenoid 9 according to the ninth embodiment relate to a sleeve 1090 and a cover unit 1030, which correspond to the sleeve 990 and the cover unit 930, respectively. The distinctions from the ninth embodiment are described below. The same reference numerals are used to identify the same elements in the ninth and tenth embodiments, and detailed descriptions thereof are omitted.

In a distinction from the sleeve 990, the sleeve 1090 includes, in its inner portion at the second side end, a protrusion 1092 protruding cylindrically from the second side end face, instead of the protrusion 992.

In a distinction from the cover unit 930, the cover unit 1030 includes a recess 1047 formed inside of the outer periphery and depressed from the end face 41a, instead of the recess 947. The protrusion 1092 of the sleeve 1090 is press-fitted into the recess 1047.

With the cover unit 1030 mounted on the housing 60, the sleeve 1090 is elastically deformed by being sandwiched between the cover unit 1030 and the outer housing 270 and contacts the cover unit 1030 and the inclined surface 74 of the second cylindrical portion 72 of the outer housing 270.

As with the solenoid 9, the solenoid 1001 configured as above also prevents foreign matters from entering the housing 60 and allows for improved productivity.

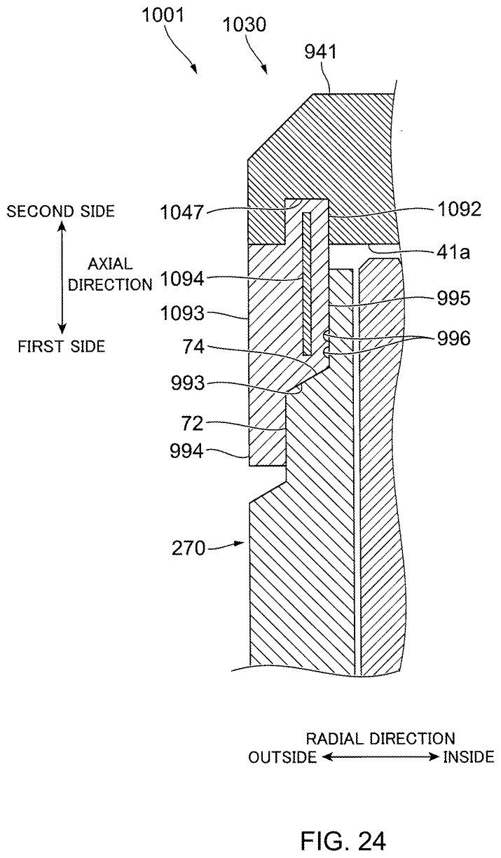

FIG. 24 illustrates an example sleeve 1093 according to a first variation.

As shown in FIG. 24, the sleeve 1093 may include a metal core 1094 within the sleeve 1093. By way of example, the metal core 1094 may be provided within an inner portion of the sleeve 1093 that includes the protrusion 1092 and contacts the inclined surface 74 of the outer housing 270, and may be in the form of a cylinder with the centerline extending in the axial direction. By virtue of having the metal core 1094, the sleeve 1093 can have increased rigidity in the axial direction, which makes it less likely to collapse even when sandwiched between the cover unit 1030 and the housing 60, thereby improving sealing. It should be noted that the location of the metal core 1094 is not limited to the interior of the sleeve 1093. For example, the metal core 1094 may be disposed on the outer or inner circumferential surface of the sleeve 1093.

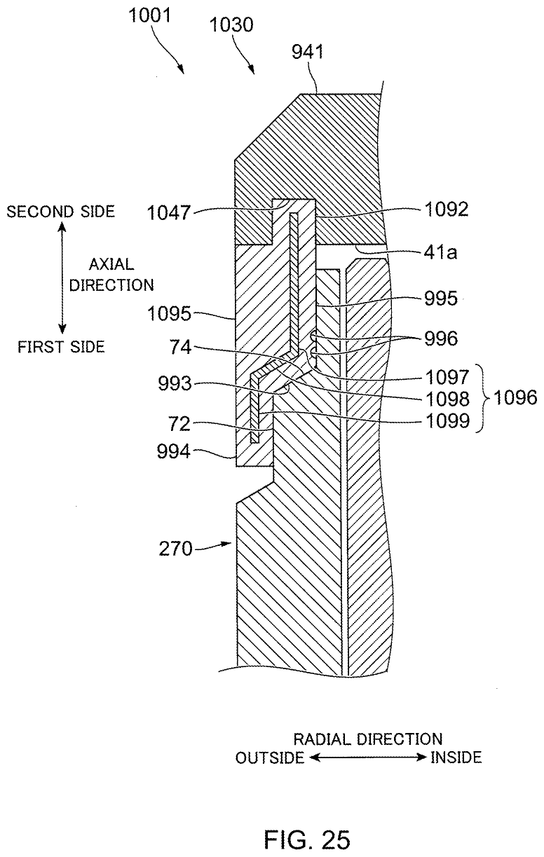

FIG. 25 illustrates an example sleeve 1095 according to a second variation.

As shown in FIG. 25, the sleeve 1095 according to the second variation includes a metal core 1096 inside that includes, unlike the metal core 1094, portions extending along the inclined surface 74 and outer circumferential surface of the second cylindrical portion 72 of the outer housing 270. In other words, the metal core 1096 includes a first cylindrical portion 1097 corresponding to the metal core 1094, an inclined portion 1098 extending in an inclined direction relative to the axial direction from the first side end of the first cylindrical portion 1097, and a second cylindrical portion 1099 extending in the axial direction from the first side end of the inclined portion 1098. By virtue of having the metal core 1096, the sleeve 1095 can have even more increased rigidity, which makes it even less likely to collapse even when sandwiched between the cover unit 1030 and the housing 60, thereby further improving sealing.

### REFERENCE SIGNS LIST

1, 2, 3, 4, 5, 6, 7, 8, 9, 1001 Solenoid

30, 230, 330, 430, 530, 630, 730, 830, 930, 1030 Cover unit

31 Coil

40, 940 Covering portion (an example of the first member)

42 Peripheral portion

60 Housing

70, 270, 370 Outer housing

90, 290, 490, 590, 690, 790, 890, 990, 1090 Sleeve (an example of the second member)

92 Protruding portion (an example of the restraining portion)

95 Sealing element

100 Suspension device

160 Damping force mechanism unit

170 Adjustment valve

180 Solenoid valve

1. A solenoid comprising:
a first member including a peripheral portion to cover a periphery of a coil contained in a cylindrical housing, the first member covering an opening of the housing;
a second member provided around an outer periphery of the first member, the second member being configured to be disassemblable; and
a sealing element disposed inside the second member, the sealing element being configured to prevent foreign matters from entering the housing, wherein
the first member and the second member include restraining portions configured to engage each other to restrain the second member from rotating about a centerline of the housing relative to the housing.

2. The solenoid according to claim 1, wherein the second member is configured to be assemblable onto the housing in a state where the second member is coupled to the first member.

3. The solenoid according to claim 1, wherein the second member is sandwiched between the first member and the housing.

4. The solenoid according to claim 1, wherein the sealing element is configured to be assemblable onto the housing in a state where the sealing element is coupled to the second member.

5. A solenoid comprising:
a first member including a peripheral portion to cover a periphery of a coil contained in a cylindrical housing, the first member covering an opening of the housing;
a second member provided around an outer periphery of the first member, the second member being configured to be disassemblable; and
a single sealing element configured to prevent foreign matters from entering the housing through between the first member and the second member and between the housing and the second member.

6. The solenoid according to claim 5, wherein the second member is configured to be assemblable onto the housing in a state where the second member is coupled to the first member.

7. The solenoid according to claim 5, wherein the second member is sandwiched between the first member and the housing.

8. The solenoid according to claim 5, wherein the sealing element is configured to be assemblable onto the housing in a state where the sealing element is coupled to the second member.

9. A solenoid comprising:
a first member including a peripheral portion to cover a periphery of a coil contained in a cylindrical housing, the first member covering an opening of the housing, the first member being provided with a recess depressed from a surface of the first member that faces the opening;
a second member of a cylindrical shape provided around an outer periphery of the first member, the second member having one end thereof contacting the recess, the second member being configured to be disassemblable from the first member;
a first sealing element disposed on a contact surface between the first member and the second member, the first sealing element being configured to prevent foreign matters from entering the housing through between the first member and the second member; and
a second sealing element with a different radial size than the first sealing element, the second sealing element being configured to prevent foreign matters from entering the housing through between the housing and the second member.

10. The solenoid according to claim 9, wherein the second member is configured to be assemblable onto the housing in a state where the second member is coupled to the first member.

11. The solenoid according to claim 9, wherein the second member is sandwiched between the first member and the housing.

12. The solenoid according to claim 9, wherein the second sealing element is configured to be assemblable onto the housing in a state where the second sealing element is coupled to the second member.

13. A method of assembling a solenoid, the solenoid comprising: a first member including a peripheral portion to cover a periphery of a coil contained in a cylindrical housing, the housing including, in a portion of a circumference thereof, a cutaway portion depressed from an outer circumferential surface thereof, the first member covering an opening of the housing; a second member including a protruding portion configured to engage the cutaway portion, the second member being provided around an outer periphery of the first member, the second member being configured to be disassemblable; and a sealing element disposed inside the second member, the sealing element being configured to prevent foreign matters from entering the housing, the method comprising:
inserting the peripheral portion into the housing in a state where the protruding portion is fitted in the cutaway portion to restrain the second member from rotating relative to the housing and the second member is coupled to an outer periphery of the first member with the sealing element disposed inside the second member.
